(19) United States
(12) Patent Application Publication
(10) Pub. No.: US 2020/0212784 A1
(43) Pub. Date: Jul. 2, 2020

(54) Linear Motor

(71) Applicant: AAC Technologies Pte. Ltd., Singapore City (SG)

(72) Inventors: Feng Tao, Shenzhen (CN); Fanghua Ling, Shenzhen (CN); Junsheng Wang, Shenzhen (CN); Xiaofeng Pu, Shenzhen (CN)

(21) Appl. No.: 16/706,837

(22) Filed: Dec. 9, 2019

(30) Foreign Application Priority Data
Dec. 30, 2018 (CN) 201822278842.X

(51) Int. Cl. H02K 33/18

(52) U.S. Cl. CPC H02K 33/18

(57) ABSTRACT

The present invention provides a linear motor. The linear motor includes a housing with an accommodation space; a vibrator and a stator accommodated in the accommodation space; and elastic support parts supporting and suspending the vibrator in the accommodation space. The vibrator includes a weight with an accommodation room, and a pole plate accommodated in the accommodation room and fixed to the weight. The pole plate includes a number of first side walls fixed to the weight and oppositely arranged, and a number of flanges bending and extending towards the elastic support parts from one end of each side wall. The flanges are fixed to the weight. Such a linear motor has higher reliability.

### FIELD OF THE PRESENT INVENTION

The present invention relates to a linear motor, particularly to a linear motor used in portable consumer electronic products.

### DESCRIPTION OF RELATED ART

With the development of electronic technology, portable consumer electronic products are more and more favored by people, such as mobile phones, handheld game consoles, navigation devices or handheld multimedia entertainment devices. These electronic products generally use linear motors for system feedback, such as the call reminder, information reminder and navigation reminder of mobile phones, vibration feedback of game consoles, etc.

In a relevant technology, a linear motor comprises a housing, a vibrating component, and an elastic support part which suspends and supports the vibrating component in the housing, wherein, the vibrating component comprises a weight with an accommodation space, and a pole plate accommodated in the accommodation space. The pole plate only closely contacts the inner surface of the weight and therefore the pole plate is easy to disconnect during use and the reliability is lower.

Thus, it is necessary to provide an improved linear motor to solve the problems above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present invention.

FIG. 1 is an isometric view of a linear motor in accordance with an exemplary embodiment of the present invention.

FIG. 2 is an exploded view of the linear motor in FIG. 1.

FIG. 3 is a cross-sectional view of the linear motor taken along line A-A in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of the present invention more apparent, the present invention is described in further detail together with the figure and the embodiment. It should be understood the specific embodiment described hereby is only to explain the invention, not intended to limit the invention.

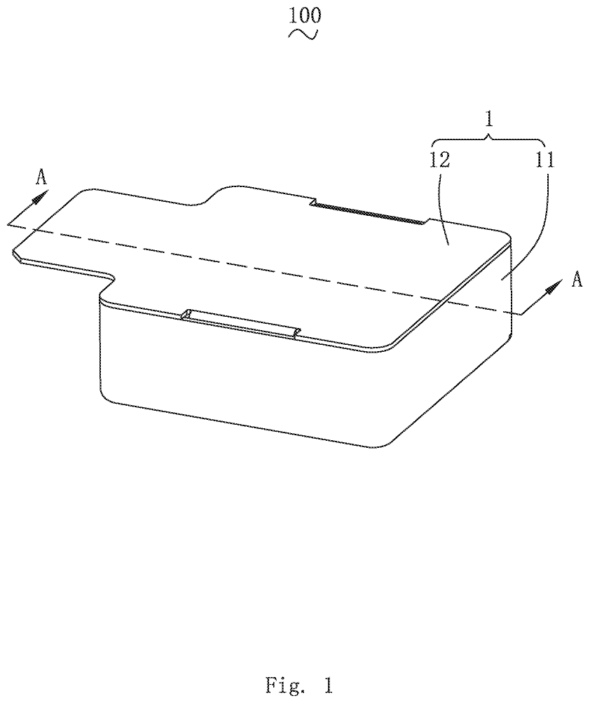

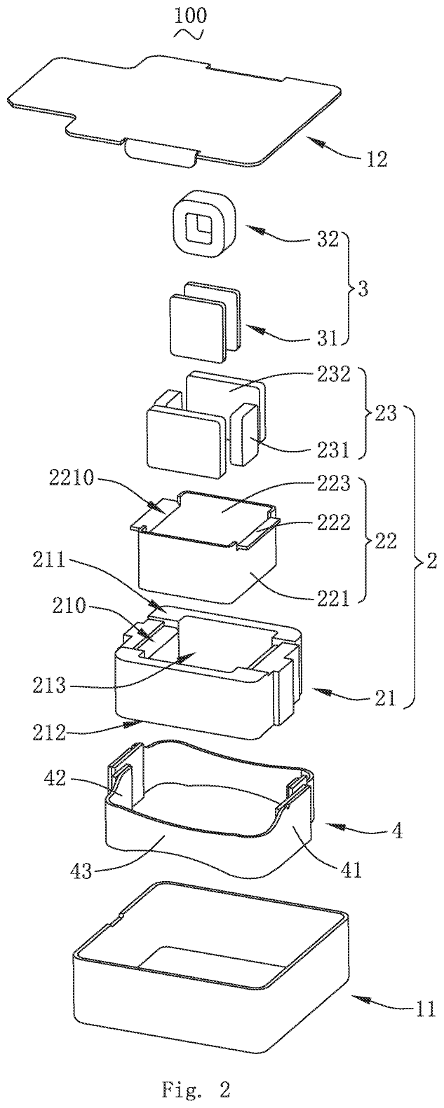

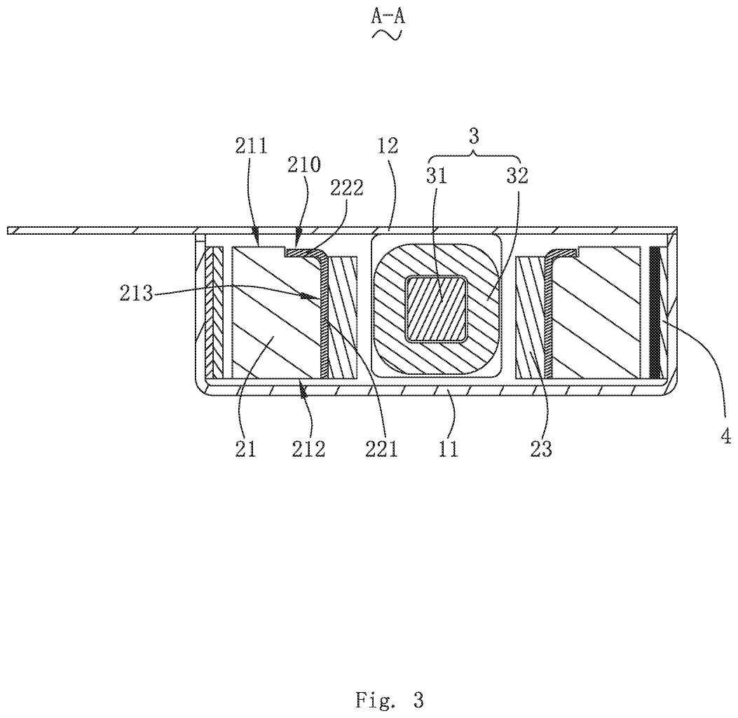

Please refer to FIGS. 1 to 3, an embodiment of the present invention provides a linear motor 100. The linear motor 100 comprises a housing 1 with an accommodation space 10, a vibrator 2 and a stator 3 accommodated in the accommodation space 10, and elastic support parts 4 supporting and suspending the vibrator 2 in the accommodation space 10.

The housing 1 comprises a housing 11 and a cover plate 12, wherein, the cover plate 12 covers the housing 11, and the cover plate 12 and the housing 1 cooperate to form the containing space 10.

The vibrator 2 comprises a weight 21, a pole plate 22 fixed to the weight 21 and a magnet assembly 23 fixed to the pole plate 22.

The weight 21 comprises an accommodation space. The pole plate 22 is fixedly accommodated in the accommodation space. The weight 21 comprises an upper surface 211 close to the cover plate 12, a lower surface 212 oppositely arranged with the upper surface 211, and an inner surface 213 connected with the upper surface 211 and the lower surface 212 to enclose to form the accommodation space. The end of the upper surface 211 close to the accommodation space is concave towards the lower surface 212 to form an avoiding part 210. The avoiding part 210 is communicated with the accommodation space.

The pole plate 22 comprises first side walls 221 fixed to the weight 21 and oppositely arranged, flanges 222 bending and extending towards the elastic support parts 4 from one end of each first side wall 221, and second side walls 223 connected with the two first side walls 221 and oppositely arranged. The first side walls 221 and the second side walls 223 are connected end to end in order to enclose to form the accommodation space of which the two ends are open. The flanges 222 bend and extend in the direction far away from the accommodation space. The second side walls 223 are fixed to the inner surface 213.

The positions of the first side walls 221 corresponding to the flanges 222 are provided with gaps 2210. The flanges 222 bend and extend from the bottoms of the gaps 2210 and the flanges 222. The first side walls 221 and the second side walls 223 are integrally formed as a whole. It can be understood that when the pole plate 22 is processed, the flanges 222 and the first side walls 221 are molded into one body. The first sidewalls 221 are outward stamped to form the flanges 222. The positions of the flanges 222 before bending correspondingly form the gaps 2210.

The flanges 222 are accommodated and fixed in the avoiding part 210 by welding. The first side walls 221 closely contact the inner surface 213. The arrangement of the flanges 222 simplifies the assembling process of the pole plate 22, which greatly lowers the cost. At the same time, the flanges 222 are fixed to the avoiding part 210, and the first side walls 221 and the second side walls 223 are fixed to the inner surface 213, which both fixes the pole plate 22 in the vibrating direction and in the direction perpendicular to the vibrating direction. Thus, the connection is firmer, the installation reliability of the pole plate 22 is improved, and the risk is reduced.

Further, the flanges 222 are located at the ends of the first side walls 221 close to the cover plate 12. Two flanges 222 are arranged. Each first side wall 221 is provided with one flange 222. In other embodiments, the number of the flanges 222 can be different, which is not limited by the present invention.

The magnet assembly 23 is fixedly accommodated in the accommodation space, and fixed to the pole plate 22. The magnet assembly 23 comprises two first magnets 231 which are arranged in parallel with an interval and two second magnets 232 which are arranged in parallel with an interval. The first magnets 231 correspond to the first side walls 221, and the second magnets 232 correspond to the second side walls 223.

The stator 3 comprises a support 31 fixed to the housing 11, and a coil 32 fixed to the support 31. The magnet assembly 23 is arranged around the coil 32 in a ring shape with an interval.

The elastic support parts 4 comprise first installation parts 41 fixed to the housing 11, second installation parts 42 oppositely arranged with the first installation parts 41 with intervals and fixed to the vibrator 2, and third installation parts 43 connecting with the first installation parts 41 and the second installation parts 42. The third installation parts 43 are suspended in the accommodation space. The first installation parts 41, the second installation parts 42 and the third installation parts 43 are molded in one body. Further, two elastic support parts 4 are provided in total, and the two elastic support parts 4 are staggered.

Compared with relevant technologies, the pole plate 22 of the linear motor 100 provided by the present invention comprises the first side walls 221 and the flanges 222 bending and extending towards the direction of the elastic support parts 4 from one end of each first side wall 221. The flanges 222 are fixed to the weight 21, which both fixes the pole plate 22 in the vibrating direction of the linear motor 100 and in the direction perpendicular to the vibrating direction. Thus, the connection reliability between the pole plate 22 and the weight 21 is improved.

It is to be understood, however, that even though numerous characteristics and advantages of the present exemplary embodiment have been set forth in the foregoing description, together with details of the structures and functions of the embodiment, the invention is illustrative only, and changes may be made in detail, especially in matters of shape, size, and arrangement of parts within the principles of the invention to the full extent indicated by the broad general meaning of the terms where the appended claims are expressed.

What is claimed is:

1. A linear motor comprising:
a housing with an accommodation space;
a vibrator and a stator accommodated in the accommodation space;
elastic support parts supporting and suspending the vibrator in the accommodation space; wherein
the vibrator comprises a weight with an accommodation room, and a pole plate accommodated in the accommodation room and fixed to the weight; the pole plate comprises a plurality of first side walls fixed to the weight and oppositely arranged, and a plurality of flanges bending and extending towards the elastic support parts from one end of each side wall; the flanges are fixed to the weight.

2. The linear motor as described in claim 1 further comprising a cover plate engaging with the housing for cooperatively forming the accommodation space; wherein the weight further comprises an upper surface close to the cover plate, a lower surface opposite to the upper surface, and an inner surface connecting the upper surface to the lower surface to enclose to form the accommodation space; an end of the upper surface close to the accommodation space is concave towards the lower surface to form an avoiding part; the first side walls closely contact the inner surface, and the flanges are accommodated in the avoiding part.

3. The linear motor as described in claim 2, wherein the flanges and the avoiding part are fixed by welding.

4. The linear motor as described in claim 2, wherein the flanges are located at ends of the first side walls close to the cover plate.

5. The linear motor as described in claim 2, wherein the pole plate further comprises a plurality of second side walls connected with the first side walls and oppositely arranged, and the second side walls are fixed to the inner surface.

6. The linear motor as described in claim 4, wherein two flanges are arranged, and each first side wall is provided with one flange.

7. The linear motor as described in claim 4, wherein positions of the first side walls corresponding to the flanges are provided with gaps, and the flanges bend and extend from bottoms of the gaps.

8. The linear motor as described in claim 4, wherein the flanges and the first side walls are integrally formed.

9. The linear motor as described in claim 1 further comprising a magnet assembly fixedly connected with the pole plate; the stator comprises a support fixed to the housing, and a coil fixed to the support; the coil keeps a distance from the magnet assembly.

10. The linear motor as described in claim 1, wherein the elastic support parts comprise first installation parts fixed to the housing, second installation parts oppositely arranged with the first installation parts and fixed to the vibrator, and third installation parts connecting the first installation parts to the second installation parts; the first installation parts, the second installation parts and the third installation parts are integrally formed.
